(19) United States
(12) Patent Application Publication
(10) Pub. No.: US 2022/0195795 A1
(43) Pub. Date: Jun. 23, 2022

(54) SCROLLING UNIT FOR ELECTRIC BLINDS

(71) Applicant: WEN YING LIANG, Changhua County (TW)

(72) Inventor: WEN YING LIANG, Changhua County (TW)

(21) Appl. No.: 17/227,228

(22) Filed: Apr. 9, 2021

(30) Foreign Application Priority Data
Dec. 22, 2020 (TW) 109216943

(51) Int. Cl. E06B 9/322

(52) U.S. Cl. CPC E06B 9/322; E06B 2009/3225

(57) ABSTRACT

A scrolling unit for electric blinds includes a top box. An electric motor and a scrolling unit are located in the top box. The electric motor includes a shaft, a plate extends axially from the shaft. The scrolling unit includes a rotary part, and the plate is inserted into a slit defined axially in the rotary part. Two ropes are spirally wrapped to the rotary part. Multiple frames are located in the top box and separate the ropes apart. The diameter of the shaft of the electric motor is different from the diameter of the rotary part. The ropes are spirally wrapped to the rotary part and do not tangle with each other.

### BACKGROUND OF THE INVENTION

### 1. Fields of the Invention

The present invention relates to a scrolling unit for electric blinds, and more particularly, to a scrolling unit that smoothly and efficiently scrolls the ropes of the blinds.

### 2. Descriptions of Related Art

The conventional electronic blinds are controlled by an electric motor to expand or lift the blinds smoothly and efficiently. There are no ropes needed for the electric blinds so as to avoid from accidents due to the ropes wrapped to kids.

However, the ropes for the electric blinds are scrolled by the electric motor, and the ropes are easily tangled to cause stop movement of the blinds. This is because the output shaft of the electric motor is connected to the center of the scrolling unit, and lacks movement of inertia. The angular inertial is almost equal to zero for both the center of the scrolling unit and the outside of the scrolling unit. Therefore, the ropes are overlapped and tangled.

Another problem for the electric blinds is that the position of the slats is difficult to be controlled precisely, the users try multiple times to adjust and position the slats at the desired position. This is because the scrolling unit controls scrolls the ropes after the electric motor stops.

The present invention intends to provide a scrolling unit for electric blinds, the ropes do not tangle and can be precisely controlled.

### SUMMARY OF THE INVENTION

The present invention relates to a scrolling unit for electric blinds, and comprises a top box in which an electric motor and a scrolling unit are located. The electric motor includes a shaft and a plate axially extends from the shaft. The scrolling unit includes a rotary part. The plate is inserted into a slit defined axially in the rotary part. Two ropes wrapped to the rotary part and extend through slats and are connected to a bottom box. The diameter of the shaft of the electric motor is different from the diameter of the rotary part. Multiple frames are located in the top box and separate the ropes apart. Therefore, when the rotary part rotates, the ropes are spirally wrapped to the scrolling unit.

Preferably, a distance is formed between the second end of the rotary part and one of the frames that is located close to the second end of the rotary part. The rotary part moves back and forth within the distance so that the ropes are spirally wrapped to the rotary part of the scrolling unit.

The primary object of the present invention is to provide a scrolling unit for electric blinds, wherein the angular momentum of the scrolling unit is increased so that the ropes are spirally wrapped to the rotary part without being tangled with each other.

The present invention have the following advantage which is that the use of the plate of the shaft increases the angular momentum of the scrolling unit, and the frames separate the two ropes. Therefore, the two respective speeds of the shaft and the rotary part are different, and the ropes are spirally wrapped to the rotary part.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electric blinds with the scrolling unit of the present invention;

FIG. 2 shows the structure of scrolling unit of the present invention;

FIG. 3 is a top view to show scrolling unit of the present invention;

FIG. 4 is a cross sectional view, taken along line A-A in FIG. 3, and

FIGS. 5 and 6 show that the rotary part move back and forth.

### DETAILED DESCRIPTION OF THE PREFERRED EMBODIMENT

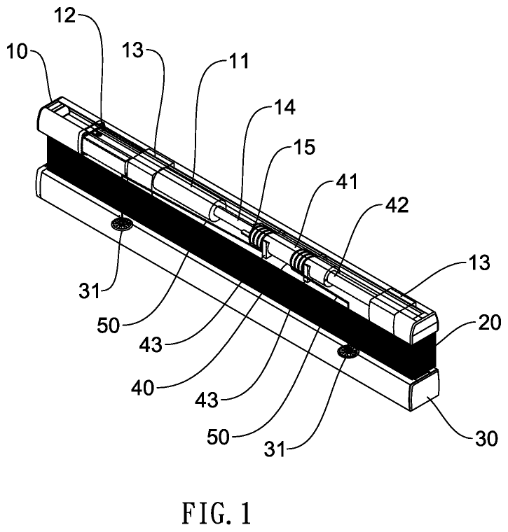

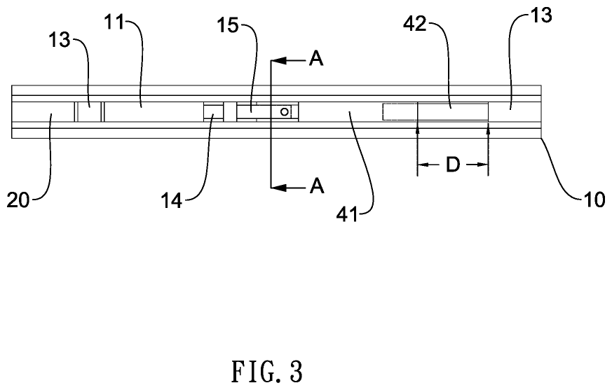

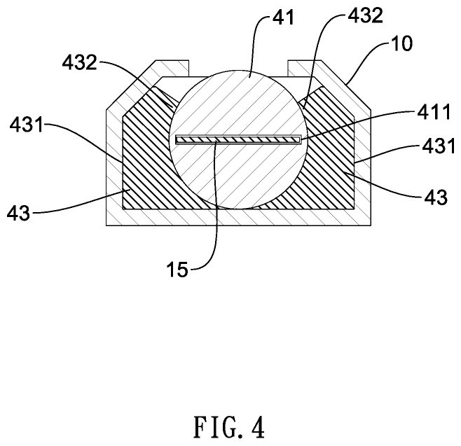

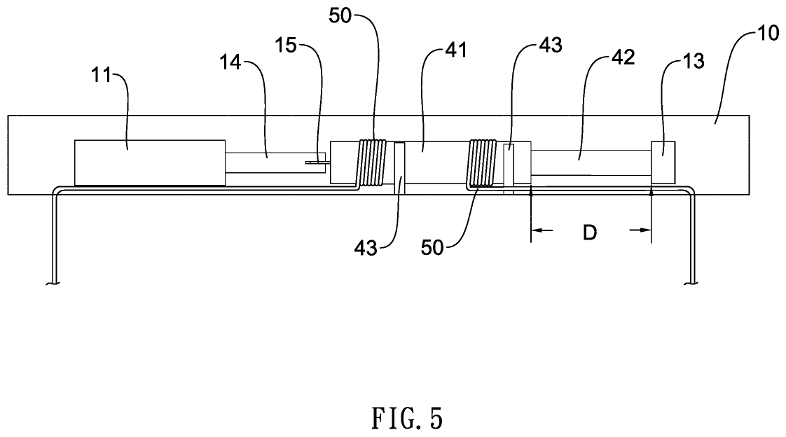

Referring to FIGS. 1 to 5, the scrolling unit for electric blinds of the present invention comprises a top box 10, multiple slats 20, a bottom box 30, a scrolling unit 40 and two ropes 50.

The top box 10 includes an electric motor 11 received therein, and a battery 12 is electrically connected to the electric motor 11 so as to provide power to the electric motor 11. Multiple separators 13 are located in the top box 10 to form multiple rooms in the top box 10. The electric motor 11 includes a shaft 14, and a plate 15 axially extends from the shaft 14.

The scrolling unit 40 including a rotary part 41 and an axle 42 which extends through the rotary part 41. The rotary part 41 is rotatably and movably mounted to the axle 42. The two ropes 50 are wrapped to the rotary part 41. Two frames 43 are located in the top box 10 and each frame 43 includes a U-shaped frame. Two protrusions 432 respectively extend from two vertical faces 431 (outsides) of each frame 43 so as to separate the two ropes 50 and to avoid the two ropes 50 from being tangled with each other.

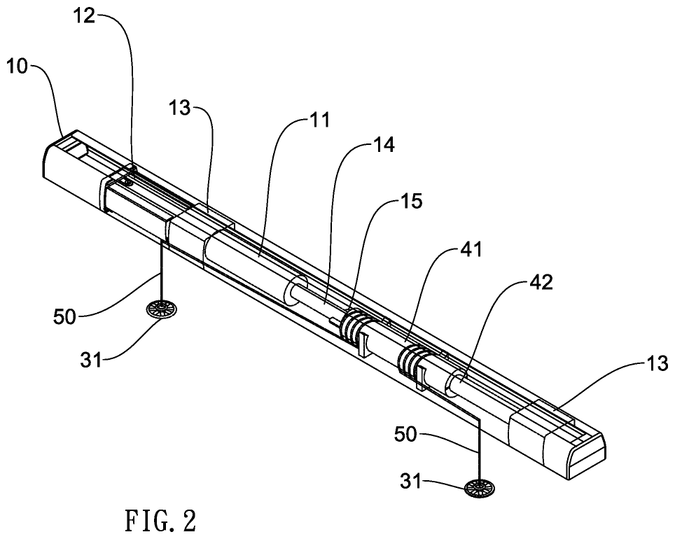

As shown in FIGS. 2 to 5, the plate 15 that extends from the shaft 14 is inserted into a slit 411 defined axially in the first end of the rotary part 41. The width of the plate 15 is equal to the diameter of the rotary part 41 or greater than a radius of the rotary part 41. By the arrangement, the rotary torque of the rotary part 41 is almost equal to zero. That is to say, the plate 15 increases the rotary torque arm so that the angular acceleration of the rotary part 41 ins increased without increasing mass of the rotary part 41. The ropes 50 are spirally wrapped to the scrolling unit 40 when the rotary part 41 rotates and do not overlapped to each other and tangle with each other.

The multiple slats 20 are located between the top box 10 and the bottom box 30. The two ropes 50 extend through two ends of the slats 20 and are connected to the bottom box 30. Each ropes 50 is connected with a stop 31 at the lower distal end thereof. When the scrolling unit 40 rotates, the ropes 50 drive the bottom box 30 to expand or lift the slats 20.

In order to ensure that the ropes 50 are spirally mounted to the rotary part 41 of the scrolling unit 40, a distance “D’ is formed between the frame 13 that is located close to the second end of the rotary part 41 and the second end of the rotary part 41. The rotary part 41 moves back and forth within the distance “D” so that the ropes 50 are spirally wrapped to the scrolling unit 40.

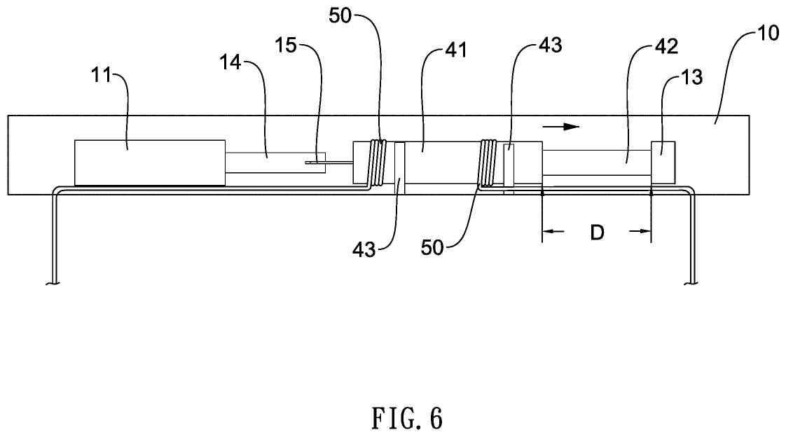

As shown in FIGS. 1 to 6, the present invention uses the plate 15 to increase the angular acceleration of the rotary part 41. The rotary speed of the rotary part 41 is different from the rotary speed of the shaft 14 of the electric motor 11. The two ropes 50 are separated by the two frames 43. The ropes 50 are spirally wrapped to the scrolling unit 40 when the rotary part 41 rotates and do not overlapped to each other and tangle with each other.

In addition, because the rotary part 41 moves back and forth within the distance “D” so that the ropes 50 are spirally wrapped to the scrolling unit 40.

While we have shown and described the embodiment in accordance with the present invention, it should be clear to those skilled in the art that further embodiments may be made without departing from the scope of the present invention.

What is claimed is:

1. A scrolling unit for electric blinds, comprising:
a top box;
an electric motor and a scrolling unit located in the top box, the electric motor including a shaft, a plate axially extending from to the shaft;
the scrolling unit including a rotary part, the plate inserted into a slit defined axially in the rotary part, two ropes wrapped to the rotary part, a diameter of the shaft of the electric motor being different from a diameter of the rotary part, the ropes spirally wrapped to the scrolling unit, and
multiple frames located in the top box and separating the ropes apart.

2. A scrolling unit for electric blinds, comprising:
a top box;
an electric motor located in the top box and connected with a battery, multiple separators located in the top box to form multiple rooms, the electric motor including a shaft, a plate axially extending from the shaft;
a scrolling unit including a rotary part and an axle which extends through the rotary part, the rotary part rotatably and movably mounted to the axle, two ropes wrapped to the rotary part, two frames located in the top box and each frame being a U-shaped frame, two protrusions respectively extending from two vertical faces of each frame so as to avoid the two ropes from being tangled;
the plate inserted into a slit defined axially in a first end of the rotary part so as to increase a torque arm and an angular acceleration of the rotary part, the ropes spirally wrapped to the scrolling unit when the rotary part rotates, and
multiple slats located between the top box and a bottom box, the two ropes extending through two ends of the slats and being connected to the bottom box, each ropes connected with a stop at a distal end thereof, when the scrolling unit rotates, the ropes drive the bottom box to expand or lift the slats.

3. The scrolling unit for electric blinds as claimed in claim 1, wherein a width of the plate is equal to a diameter of the rotary part or greater than a radius of the rotary part.

4. The scrolling unit for electric blinds as claimed in claim 2, wherein a width of the plate is equal to a diameter of the rotary part or greater than a radius of the rotary part.

5. The scrolling unit for electric blinds as claimed in claim 2, wherein a distance is formed between the frame and a second end of the rotary part, the rotary part moves back and forth within the distance so that the ropes are spirally wrapped to the scrolling unit.
